(19) United States
(12) Patent Application Publication
(10) Pub. No.: US 2004/0265146 A1
(43) Pub. Date: Dec. 30, 2004

(54) Roots compressor module

(76) Inventors: Masanao Kagami, Kariya-shi (JP); Takayuki Hirano, Kariya-shi (JP); Kazuho Yamada, Kariya-shi (JP)

Correspondence Address: MORGAN & FINNEGAN, L.L.P., 3 WORLD FINANCIAL CENTER, NEW YORK, NY, 10281-2101, US

(21) Appl. No.: 10/861,291

(22) Filed: Jun. 4, 2004

(30) Foreign Application Priority Data
Jun. 6, 2003 (JP) 2003-162833

(51) Int. Cl. F01C 1/02; F03C 2/00

(52) U.S. Cl. 417/410.3; 417/410.4; 417/313; 417/311

(57) ABSTRACT

A roots compressor module has a roots compressor accommodating drive and driven rotors in a rotor chamber of a compressor housing, an electric motor arranged coaxially with the drive rotor and having a motor housing fixedly connected to the compressor housing, a first device supported on one of the compressor and motor housings, a discharge passage formed in the compressor housing and extending from a discharge side of the rotor chamber in a direction perpendicular to an axis of the drive rotor, and a communication passage connecting the discharge passage with the first device. The first device is located by a side of the electric motor, while the communication passage extends from the discharge passage toward the first device along the axial direction of the drive rotor.

### BACKGROUND OF THE INVENTION

The present invention relates to a roots compressor module.

As shown in FIGS. 4 and 5, a roots compressor module includes a roots compressor 51 and an electric motor 52 which are integrated with each other, as disclosed on pages 3 and 4 and FIGS. 2 and 3 of Unexamined Japanese Patent Publication No. 2001-12375. The roots compressor 51 includes a compressor housing 51a which includes therein a rotor chamber 53. The rotor chamber 53 accommodates therein a drive rotor 54 and a driven rotor 55. The electric motor 52 is provided coaxially with the drive rotor 54 for driving the drive rotor 64 and the driven rotor 55. A motor housing 52a which is a casing of the electric motor 52 is fixedly connected to the compressor housing 51a.

The roots compressor module of the above Publication has formed therein a large volumetric space 56 adjacent to the compressor housing 51a. The compressor housing 51a includes therein a discharge passage 57 extending from the discharge side of the rotor chamber 53 in the direction perpendicular to the axis L of the drive rotor 54 and extending the different side where the space 56 is formed. The discharge passage 57 is in communication with the space 56 through a communication passage 58 which is formed near one end of the compressor housing 51a. The communication passage 58 extends from the discharge passage 57 along the circumferential direction of the compressor housing 51a thereby to communicate with the space 56.

Then, gas discharged from the rotor chamber 53 is expanded by passing through the space 56 thereby to reduce pulsation of the gas discharged from the roots compressor module. That is, the space 56 serves as a muffler device for reducing pulsation of the gas discharged from the roots compressor 51. It is noted that the space 56 may be replaced by a filter device for filtering gas discharged from the roots compressor 51 or a gas cooler device for cooling gas discharged from the roots compressor 51 at the position thereof depending upon application of the roots compressor module.

An unwanted feature is that the roots compressor module includes the space 56 protruding laterally from the compressor housing 51a and a thickened wall 59 protruding laterally from another portion of the compressor housing 51a for forming therein the communication passage 58. Accordingly, outer shape of the cross-section perpendicular to the axis of the compressor housing 51a grows in size in two directions, that is, the side of the space 56 and the side of the communication passage 58, so that the size of the roots compressor module increases. Therefore, there is a need for a compact roots compressor module.

### SUMMARY OF THE INVENTION

In accordance with the present invention, a roots compressor module has a roots compressor, an electric motor, a first device, a discharge passage and a communication passage. The roots compressor accommodates a drive rotor and a driven rotor in a rotor chamber which is formed in a compressor housing. The electric motor is arranged coaxially with the drive rotor for rotating the drive rotor and the driven rotor and has a motor housing, which is a casing of the electric motor, fixedly connected to the compressor housing. The first device is supported on one of the compressor housing and the motor housing for processing gas discharged from the roots compressor. The discharge passage is formed in the compressor housing and extends from a discharge side of the rotor chamber in a direction perpendicular to an axis of the drive rotor. The communication passage connects the discharge passage with the first device. The first device is located by a side of the electric motor, while the communication passage extends from the discharge passage toward the first device along a direction of the axis of the drive rotor.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a schematic perspective view of an air supply system according to a first preferred embodiment of the present invention;

FIG. 2 is a cross-sectional view of a roots compressor module according to the first preferred embodiment of the present invention;

FIG. 3 is a cross-sectional view of a roots compressor module according to a second preferred embodiment of the present invention;

FIG. 4 is a plan view of a roots compressor module according to a prior art; and

FIG. 5 is a cross-sectional view that is taken along the line V-V in FIG. 4.

### DETAILED DESCRIPTION OF THE PREFERRED EMBODIMENTS

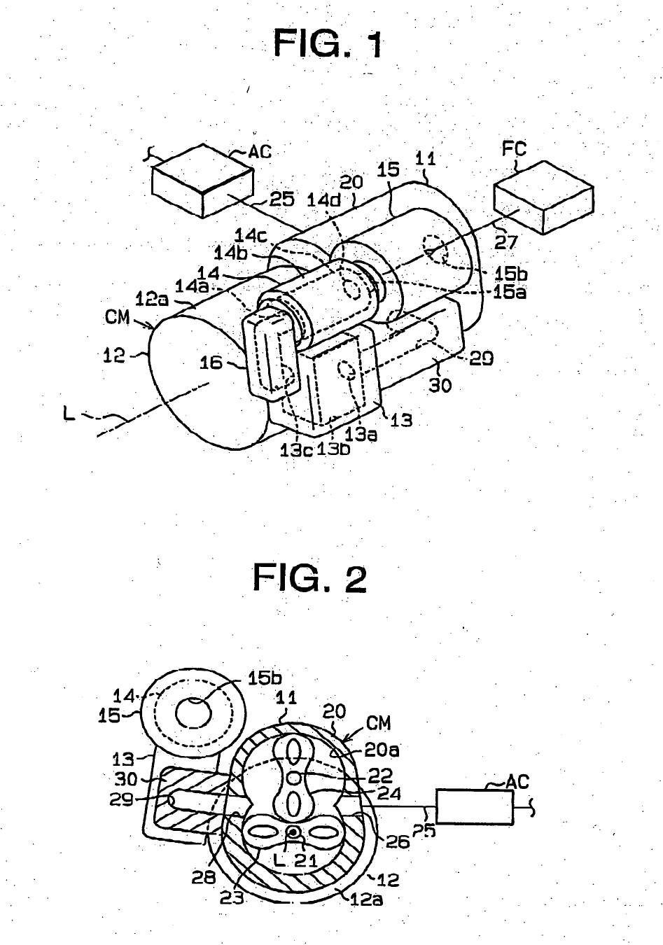

A first preferred embodiment of a roots compressor module mounted on a fuel-cell vehicle according to the present invention will now be described with reference to FIGS. 1 and 2.

FIG. 1 is a schematic diagram illustrating an air supply system centering on a roots compressor module (hereinafter, the compressor module) CM for supplying air to a fuel cell of the fuel-cell vehicle. An air cleaner AC is connected to the suction side of the compressor module CM through an external conduit 25. The compressor module CM introduces the atmosphere (air) through the air cleaner AC and the external conduit 25. The fuel cell FC is connected to the discharge side of the compressor module CM through an external conduit 27. The air compressed in the compressor module CM is supplied to the fuel cell FC through the external conduit 27.

The compressor module CM includes a roots compressor 11 and an electric motor 12 which are integrated with each other. As shown in FIG. 2, a compressor housing 20 which is a casing of the roots compressor 11 includes therein a rotor chamber 20a having a shape of gourd in its cross-section. The compressor housing 20 rotatably supports a drive shaft 21 and a driven shaft 22 such that the shafts 21, 22 extend through the rotor chamber 20a, respectively.

The drive shaft 21 is rotated by power supplied from the electric motor 12. The driver shaft 22 is located in parallel relation to the drive shaft 21 and rotated by power transmitted from the drive shaft 21 through a gear (not shown). The drive shaft 21 is located at the lower side of the roots compressor 11, while the driven shaft 22 in located at the upper side of the roots compressor 11. In the rotor chamber 20a, a two-lobe drive rotor 23, is secured to the drive shaft 21 so as to rotate integrally therewith, and a two-lobe driven rotor 24 is similarly secured to the driven shaft 22 so as to rotate integrally therewith. The electric motor 12 rotates the drive rotor 23 and the driven rotor 24 through the drive shaft 21 and the driven shaft 22, respectively. In the first preferred embodiment, the direction of the axis L of the drive rotor 23 is defined as the longitudinal direction of the compressor module CM. In addition, the side of the roots compressor 11 is forward and the side of the electric motor 12 is backward in the longitudinal direction.

As shown in FIGS. 1 and 2, the electric motor 12 is located coaxially with the drive rotor 23. A motor housing 12a which is a casing of the electric motor 12 is fixedly connected to the compressor housing 20. The compressor housing 20 includes therein a suction passage 20 connected to the suction side of the rotor chamber 20a. The suction passage 26 extends perpendicularly to the axis L of the drive rotor 23 toward the right side of the compressor housing 20 in FIG. 2. The air cleaner AC is connected to the suction passage 26 through the external conduit 25.

The compressor housing 20 includes therein a discharge passage 28 connected to the discharge side of the rotor chamber 20a. The discharge passage 28 extends perpendicularly to the axis L of the drive rotor 23 and toward the opposite side relative to the suction passage 26, that is, the left side in FIG. 2.

A muffler or a first device 13 is assembled to the compressor module CM. The discharge passage 28 of the roots compressor 11 is in communication with an inlet 13a of the muffler 13 through the communication passage 29 formed in the compressor housing 20. The box-shaped muffler 13 is supported on a thickened wall 30 which protrudes laterally from the compressor housing 20 for forming therein the communication passage 29.

The expansion-type muffler 13 is provided with a large volumetric space 13b. In other words, the muffler 13 reduces pulsation of the air discharged from the compressor 20 by expanding volume of the air discharged from the rotor chamber 20a. The muffler 13 is located by the side of the electric motor 12. The communication passage 29 extends from the side of the discharge passage 28 toward the side of the electric motor 12 along the direction of the axis L of the drive rotor 23.

An outlet 13c of the muffler 13 is connected to an inlet 14a of a filter or a second device 14 through a connecting conduit 16. The filter 14 is supported on the compressor housing 20 through the connecting conduit 16 and the muffler 13. The filter 14 is located at the upper side of the muffler 13 and by the side of the electric motor 12. The filter 14 has a filtering element 14c accommodated in a casing 14b thereof for removing, for example, particles generated due to abrasion of the roots compressor 11 by filtering the air discharged from the roots compressor 11 through the muffler 13. The filter 14 is arranged such that the axis of the filter 14 is in parallel relation to the axis L of the drive rotor 23.

An inlet 15a of a gas cooler or a third device 15 is connected to an outlet 14d of the filter 14. The gas cooler 15 is supported on the compressor housing 20 through the filter 14, the connecting conduit 16 and the muffler 13. The cylindrical gas cooler 15 has a larger diameter than the filter 14. The gas cooler 15 is located coaxially with the filter 14. The gas cooler 15 is provided with a water-cooled cooling system circuit (not shown) for cooling the discharged air flowing into the gas cooler 15 by coolant flowing in the cooling system circuit.

In the first preferred embodiment, a portion of the cooling system circuit is branched for cooling the roots compressor 11 and the electric motor 12. The fuel coil FC is connected to an outlet 15b of the gas cooler 15 through the external conduit 27.

According to the first preferred embodiment, the following advantageous effects are obtained.

(1) As described above, the muffler 13 is located by the side of the electric motor 12. Also, the communication passage 29 is connected to the muffler 18 so as to extend from the side of the discharge passage 28 of the roots compressor 11 toward the side of the electric motor 12 along the direction of the axis L of the drive motor 23 of the roots compressor 11. Accordingly, when the compressor module CM is seen in the direction of the axis L, the compressor module CM is arranged such that the thickened wall 30 for forming therein the communication passage 29 is overlapped on the muffler 13 thereby to make the compressor module CM smaller by this overlap.

(2) The compressor housing 20 supports the filter 14 through the muffler 13 and the connecting conduit 16 and also supports the gas cooler 15 through the filter 14. Then, the three devices constituted of the muffler 13, the filter 14 and the gas cooler 15 are modularized with the roots compressor 11 and the electric motor 12. Therefore, installation of the three devices is easier. Additionally, the modularization makes it possible to shorten or remove the connecting conduits between the muffler 13 and the filter 14 and between the filter 14 and the gas cooler 15, respectively, thereby to reduce the number of components, weight, and pressure loss of air.

(3) The modularization of the three devices makes it possible to include a structure for cooling the roots compressor 11 and the electric motor 12 by branching a portion of the cooling system circuit of the gas cooler 15. Accordingly, a cooling conduit for the roots compressor 11 and a cooling conduit for the gas cooler 15 are directly connected without passing through any external conduits thereby to further reduce the number of components, weight, and pressure loss of coolant.

(4) The filter 14 is located by the side of the electric motor 12. The gas cooler 15 is located by the side of the roots compressor 11. The filter 14 and the gas cooler 15 are arranged in line along the direction of the axis L of the drive rotor 23. That is, the filter 14 and the gas cooler 15 are arranged such that air flowing in the communication passage 29 from the side of the roots compressor 11 toward the side of the electric motor 12 is changed to flow from the side of the electric motor 12 toward the side of the roots compressor 11. Accordingly, for example, in comparison to an arrangement which the muffler 13, the filter 14 and the gas cooler 15 are in line along the direction of the axis L of the drive rotor 23, the compressor module CM is prevented from growing in size in the direction of the axis L.

(5) The muffler 13 is located upstream of the gas cooler 16. Therefore, when pulsation occurs on the air discharged from the roots compressor 11, the discharged air flows into the gas cooler 15 after the pulsation is reduced in the muffler 13. Accordingly, noise generation due to pulsation of the discharged air is prevented in the gas cooler 15 which has a relatively thin wall for serving as a heat exchanger.

(6) The roots compressor 11 is used for feeding air (oxygen contained in the air) to the fuel cell FC mounted on the fuel-cell vehicle. The arrangement space is particularly limited for the on-vehicle compressor module CM, so that the compact compressor module CM according to the first preferred embodiment is effective for such on-vehicle components.

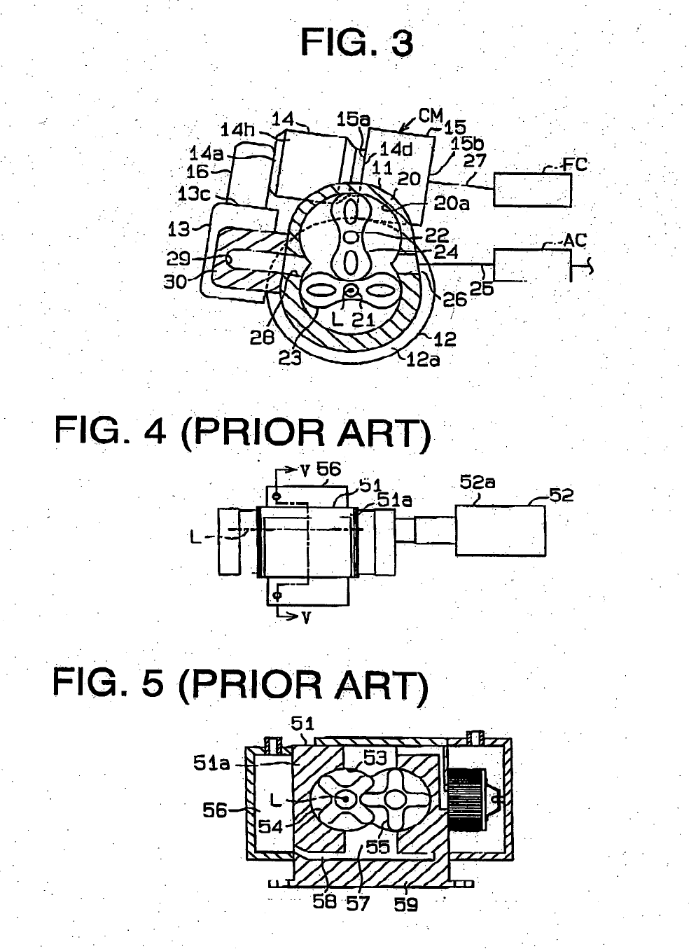

A second preferred embodiment of the roots compressor module according to the present invention will now be described with reference to FIG. 3. It is noted that the same reference numerals denote substantially identical components to those of the first preferred embodiment.

As shown in FIG. 3 according to the second preferred embodiment, the filter 14 and the gas cooler 15 are located by a side of the electric motor 12, and also the muffler 13, the filter 14 and the gas cooler 15 are in line along the circumferential direction of the electric motor 12. That is the filter 14, and the gas cooler 15 are arranged such that the air flowing in the communication passage 29 from the side of the roots compressor 11 toward the side of the electric motor 12 is changed to flow in the circumferential direction of the electric motor 12. Accordingly, for example, in comparison to an arrangement which the muffler 13, the filter 14 and the gas cooler 15 are in line along the direction of the axis L of the drive rotor 23, the compressor module CM is prevented from growing in size in the direction of the axis L.

The filter 14 and the gas cooler 15 are located by the side of the electric motor 12 so as to face the driven rotor 24. That is, the filter 14 and the gas cooler 15 are partially located in a space (dead space) which is formed where the electric motor 12 faces the driven rotor 24. Accordingly, when the compressor module CM is seen in the direction of the axis L, the filter 14 and the gas cooler 15 are partially overlapped with the driven rotor 24 of the roots compressor 11 thereby to make the compressor module CM further smaller. It is noted that the side where the air is discharged from the compressor module CM is the same side as the side where the air flows into the compressor module CM.

The present invention is not limited to the embodiments described above but may be modified into the following alternative embodiments.

In the first preferred embodiment the air discharged from the compressor module CM is discharged forward relative to the compressor module CM, while in the second preferred embodiment the air is discharged toward the right side in FIG. 2 that is the same side as the side where the air flows into the compressor module CM. These designations correspond to the layout of the fuel cell FC and the compressor module CM, and, therefore, the arrangement of the filter 14 and the gas cooler 15 may be changed in accordance with the changing of the layout.

In the above described preferred embodiments, the muffler 13, the filter 14 and the gas cooler 15 are supported on the compressor housing 20. In other words, the connecting conduit 16 is supported on the compressor housing 20 through the muffler 13, the filter 14 is supported on the compressor housing 20 through the muffler 13 and the connecting conduit 16, and the gas cooler 15 is supported on the compressor housing 20 through the filter 14, the muffler 13 and the connecting conduit 16. In an alternative embodiment, the muffler 13, the filter 14 and the gas cooler 15 are supported on the motor housing 12a.

In the above described preferred embodiments, the muffler 13 serves as the first device, the filter 14 serves as the second device and the gas cooler 15 serves as the third device. In an alternative embodiment, arrangement of the muffler 13, the filter 14 and the gas cooler 15 to the first through third devices is not limited to the above arrangement but another assignment may be applicable. For example, the first device may be arranged to the muffler 13, the second device may be arranged to the gas cooler 15, and the third device may be arranged to the filter 14.

Also, the first device may be arranged to the filter 14, and the second and third devices may be arranged to the muffler 13 and the gas cooler 15, respectively, or may be arranged to the gas cooler 15 and the muffler 13, respectively. Furthermore, the first device may be arranged to the gas cooler 15, and the second and third devices may be arranged to the muffler 13 and the filter 14, respectively, or may be arranged to the filter 14 and the muffler 13, respectively.

In the above described preferred embodiments, three devices (the muffler 13, the filter 14 and the gas cooler 15) are assembled to the compressor module CM, but it is not limited. In an alternative embodiment, the number of assembled devices may be one, two, or equal to or more than four.

In the above described preferred embodiments, the muffler 13 is of an expansion type, but it is not limited. In an alternative embodiment, the muffler 13 may be of a resonance type or may be of an extension type.

In the above described preferred embodiments, the compressor module CM is used for feeding air (oxygen contained in the air) to the fuel cell FC of the fuel-cell vehicle but it is not limited. In an alternative embodiment, the compressor module CM may be used for feeding hydrogen to the fuel cell FC.

In the above described preferred embodiments, the drive rotor 23 and the driven rotor 24 of the roots compressor 11 each have a two-lobe shape, but it is not limited. In an alternative embodiment, the rotors 23, 24 may have a three-lobe shape or may have a three-dimensionally twisted shape.

Therefore, the present examples and embodiments are to be considered as illustrative and not restrictive, and the invention is not to be limited to the details given herein but may be modified within the scope of the appended claims.

What is claimed is:

1. A roots compressor module comprising:
a roots compressor accommodating a drive rotor and a driven rotor in a rotor chamber which is formed in a compressor housing;
an electric motor arranged coaxially with the drive rotor for rotating the drive rotor and the driven rotor, a motor housing which is a casing of the electric motor being fixedly connected to the compressor housing;
a first device supported on one of the compressor housing and the motor housing for processing gas discharged from the roots compressor;
a discharge passage formed in the compressor housing and extending from a discharge side of the rotor chamber in a direction perpendicular to an axis of the drive rotor; and
a communication passage connecting the discharge passage with the first device, wherein the first device is located by a side of the electric motor, while the communication passage extends from the discharge passage toward the first device along a direction of the axis of the drive rotor.

2. The roots compressor module according to claim 1, further comprising:
a second device supported on one of the compressor housing and the motor housing for differently processing the gas from the first device; and
a third device supported on the other of the compressor housing and the motor housing for differently processing the gas from the first device and the second device.

3. The roots compressor module according to claim 2, wherein the second device is located by a side of the electric motor, the third device being located by a side of the roots compressor, the second device and the third device are arranged in line along the direction of the axis of the drive rotor.

4. The roots compressor module according to claim 2, wherein the second device and the third device are located by a side of the electric motor, the first device, the second device and the third device are arranged in line along an circumferential direction of the electric motor.

5. The roots compressor module according to claim 2, wherein the first device is one of a muffler, a filter and a gas cooler, the second device being another of the muffler, the filter and the gas cooler, the third device being the other of the muffler, the filter and the gas cooler.

6. The roots compressor module according to claim 5, wherein the muffler is located upstream of the gas cooler.

7. The roots compressor module according to claim 5, wherein the filter is located coaxially with the gas cooler.

8. The roots compressor module according to claim 1, wherein the roots compressor is used for feeding oxygen or hydrogen to a fuel cell mounted on a fuel-cell vehicle.
